(19) United States
(12) Patent Application Publication
(10) Pub. No.: US 2023/0386438 A1
(43) Pub. Date: Nov. 30, 2023

(54) AUDIO SIGNAL MANAGEMENT SYSTEM

(71) Applicant: Bad Cat Holdings, LLC, Costa Mesa, CA (US)

(72) Inventor: Peter Arends, Costa Mesa, CA (US)

(21) Appl. No.: 18/326,254

(22) Filed: May 31, 2023

Related U.S. Application Data
(60) Provisional application No. 63/347,134, filed on May 31, 2022.

(51) Int. Cl. G10H 1/053; G10H 1/00

(52) U.S. Cl. CPC G10H 1/053; G10H 2210/195; G10H 1/0008

(57) ABSTRACT

Audio signal management systems and methods are contemplated herein which can be incorporated into amplifiers and recording equipment receiving audio signals from a musical instrument. Such systems and methods allow for a smooth, natural-sounding decay of the wanted signals of the musical instrument while reducing unwanted signals of the musical instrument. An overdriven signal may be simulated and, after processing this signal, sent to a filter transistor which may receive both this processed signal and an out signal, based on the measured output signal of the musical instrument, to produce a signal to be amplified/recorded via an attenuation circuit. The filter transistor may respond dynamically to the received processed signal to create a smooth, natural-sounding decay of the wanted signals of the musical instrument. The methods and systems may incorporate additional elements including high pass filter transistors and mute circuits to remove unwanted signals and noise floor.

### CROSS-REFERENCE TO RELATED APPLICATIONS

This application relates to and claims the benefit of U.S. Provisional Application No. 63/347,134 filed May 31, 2022, and entitled “AUDIO SIGNAL MANAGEMENT SYSTEM,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present invention relates to audio signal management systems used in sound amplifiers and recording equipment associated with musical instruments. More specifically, the present invention relates to audio signal management systems that allow for the smooth decay of the of wanted signals and the filtering out of unwanted signals that emanate from the musical instrument.

### 2. Related Art

In the present world of sound amplification, and in particular electric guitar amplification of heavily overdriven guitars, a common challenge found both when performing live in front of an audience and when recording in a studio is the management of unwanted noise signals (hiss, hum, buzz, external interferences etc.) which can emerge due to the process of amplifying the sound signal. The goal is to focus on and emphasize the wanted noise signals (the desired note(s) that emanate from the instrument upon playing it that the musician wants a listener to hear) while minimizing these unwanted noise signals that would otherwise disguise and mask the desirous wanted noise signals.

Depending on the type of instrument being played, these unwanted noise signals may linger in the moments after the wanted signals are played. In the example of an electric guitar, the hum from the distorted signal may continue to be amplified by an amplifier, even long after the musician has stopped strumming the strings of the guitar. The electric circuitry systems found on several amplifiers may incorporate a device called a ‘noise gate’ which helps to reduce or ‘gate’ noises from a musical instrument from being amplified. Such devices function in a straightforward way: the noise gate will cut off any signal from being amplified under a certain threshold of a specific electrical parameter and value (i.e., when the wanted signal is not being produced). As such noise gates function at a binary level: either amplify sound if above a threshold/parameter, or don't amplify sound if below this threshold/parameter.

However, these noise gates, as effective as they are, have practical drawbacks that stem from this binary nature of a strict cutoff of signals. Noise and music produced from instruments may be much more satisfying and natural-sounding to the human ear if there is a smooth fade out/decay of the wanted signals in certain circumstances of a musical piece (such as fading out at the end of a song or during a brief period of rest following a solo). Noise gates do not make a distinction between the types of audio signals received and consequently they act upon both the wanted and unwanted signals equally. Therefore, noise gates can prevent a smooth decay effect from occurring, either by cutting off the noise abruptly or by failing to cutoff the unwanted noise signals and thus continuing to amplify those signals, even after the wanted signals have substantially dissipated. In studio recordings, audio engineers may spend hours editing recorded guitars tracks in the studio in which they cut out and filter the unwanted noise signals as well as recreate the desired fade-out effects.

In addition, amplifiers and recording equipment can record numerous types of undesired interferences that are generated from playing the instrument and/or the sound amplification process. These can include low frequency rumbling that can overshadow the wanted signals of the musical instrument when it is played in high registers as well as the more omnipresent “noise floor” which consistently creates a disturbance, an example of which being the buzz from an overdriven amplifier. These unwanted sounds can mask the wanted sound produced by the musical instrument, making it a desirable goal to remove such sounds and prevent them from being amplified/recorded alongside the wanted signals. Prior art equipment gives less than desirable results at filtering or otherwise removing such noises. As such, it can be seen that improved audio signal management systems are needed which reduce the amplification of unwanted noise signals as well as allow for the natural-sounding decay of wanted noise signals.

### BRIEF SUMMARY

To solve these and other problems, audio signal management systems and methods are contemplated which allow for a smooth and natural-sounding fade-out effect to be simulated and subsequently amplified/recorded by an amplifier/recording equipment a musical instrument is associated with. Such methods and systems may additionally remove or reduce some unwanted signals from being amplified/recorded. According to a first exemplary embodiment, an audio signal management system may comprise two circuits, a main circuit and a simulator circuit, which both simultaneously analyze a measured input audio signal from a musical instrument and an audio output signal from the same musical instrument. The simulator circuit may incorporate an adjustable trigger which, in response to the measured input audio signal, may simulate a high-gain overdriven signal. This overdriven signal may be processed and filtered through numerous optional stages including moving filters, rectifiers, and comparators to produce a processed signal.

A filter transistor may receive this processed signal alongside an out signal based on the output signal of the musical instrument to produce a signal to be received by an attenuation circuit. This filter transistor may be configured as an N channel JFET, in which the processed signal is received at the gate terminal and the out signal is received at the drain terminal. This could allow the main filter transistor to act as a dynamic filter, reacting to the signal received at the gate terminal to determine the amount and nature of the signal received at the drain terminal to pass through to the source terminal and to the attenuation circuit.

The simulator circuit can incorporate additional filter transistors and/or additional attenuation circuits. The additional filter transistors may receive the same processed signals and act in succession with one another, in which the output from the source terminal one filter transistor may be received at the drain terminal of another filter transistor. One or more attenuation circuits may follow each of the filter transistors present, which may receive an output from the source terminal of these filter transistors. As such, the operation of the filter transistor(s) and processing feature(s) in the simulator circuit may determine the signals received by the attenuation circuit(s), which ideally may work harmoniously to simulate a natural-sounding decay to be recorded/amplified. The simulator filters may also function as low pass filters, which can eliminate high frequency unwanted signals like hissing and prevent them from reaching the attenuation circuit(s).

The simulator circuit may also comprise comparators which may produce the processed signal to be received by the filter transistors. These comparators may compare a received signal with that of a signal based on a power source with a particular voltage; this signal may function so as to set thresholds/limits to affect the degree on which processed signals derived from the input signal of the musical instrument may affect the operation of the filter transistors. Potentiometers may be present in the simulator circuit which can adjust the voltage signal of the power source before it is received by one of the comparators. An offset signal measurement may occur after the output from a level potentiometer, which could be used to determine the threshold value of different potentiometers associated with different comparators in the same simulator circuit. As such, the level potentiometer and the offset signal measurement may determine the sensitivity of multiple comparators in the simulator circuit. The offset signal may be sent through additional potentiometers before being received at a particular comparator. Such a configuration may allow one central voltage from a power source to determine the threshold/limits of multiple if not all of the comparators in the simulator circuit.

The main circuit may include numerous features that work alongside the simulator circuit, including input and output sources for the musical instrument and measurements of the input and output signals used by the simulator circuit. The main circuit may comprise a gate trigger signal which may be based on a gate trigger measurement made by the simulator circuit via measuring the overdriven signal output from the adjustable gate trigger. This signal may also be processed through filters, rectifiers, and comparators before being received by one or more attenuation transistors and a mute transistor. These gate transistors may be N channel JFETs similar to the filter transistors in the simulator circuit in that they can receive at their drain terminal an out signal based on the musical instrument's measured output signal as well as this processed signal at their gate terminal to determine the amount and nature of a resultant output from the source terminal to flow through to any following attenuation circuits and mute circuits that may be present.

In an ideal operation, the attenuation transistor and attenuation circuit can further contribute to the decay and fade-out effect until the mute transistor activates, causing the mute circuit to mute any remaining noise floor that remains. As a result, the system can be configured such that a satisfying natural-sounding decay may be created until little wanted signal remains, after which the remaining noise floor can be removed and prevented from being amplified/recorded. The processing procedures and the interaction of any comparators with any power source(s) present may be configured in similar fashion to those in the simulator circuit.

The gate trigger signal of the main circuit may also be processed differently and elsewhere such that these processed signals are received at the gate terminals of high pass filter transistors, which may also be configured as N channel JFETs. These high pass filter transistors may receive a signal based on the input signal from the musical instrument at their drain terminals and at least partially produce the output signal of the musical instrument from their source terminals. This leg of the main circuit may be constructed and configured such that when an input signal corresponding to an instrument being played in high registers is received, the high pass filter transistors may activate and remove low frequency unwanted noise from the input signal, such as low frequency rumble.

Any filters used to process a signal may be of the form of a moving filter, including high pass filters, low pass filters, bandpass filters, and shelving filters (which includes high shelf filters and low shelf filters). Examples of filters used to process the overdriven signal in here include a +12 dB high shelf filter at a set frequency of 66 Hz and a 2^{nd} order Bessel low pass filter with a set frequency of 5 kHz.

A rectifier present in the circuitry may serve to correlate an incoming received signal to trigger proceeding stages in proportion to the incoming signal of one or more separate rectifiers present in the circuitry. This could allow the signals processed by the simulator circuit to be amplified/recorded at the same time as the corresponding signals from the main circuit are amplified/recorded such that a proper matching up of the signals to be amplified/recorded occurs.

According to a second exemplary embodiment, a method of creating a smooth decay of wanted signals from a musical instrument is contemplated. This method may comprise measuring steps in which an input signal and an output signal of an instrument are measured, with the output signal being based on the input signal. An overdriven signal can be produced in response to a break in playing the musical instrument, which may then be processed before being received by at least one filter transistor alongside an out signal based on the measured output signal. In response to receiving these signals, the filter transistor may produce a signal to be received by at least one attenuation circuit which in turn may create the desired decay effect. The overdriven signal may be produced via a trigger input receiving a trigger input signal based on the measured input signal. The filter transistor may take the form of an N channel JEFT, in which the processed signal is received at the gate terminal and the out signal is received at the drain terminal.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exemplary preferred embodiment of a simulator electric circuit; and

FIG. 2 is an exemplary preferred embodiment of a main circuit.

Common reference numerals are used throughout the drawings and the detailed description to indicate the same elements.

### DETAILED DESCRIPTION

Contemplated herein are systems and methods which can be implemented in instrument amplifiers and recording equipment. Such systems and methods may analyze and modify audio signals generated from an instrument so as to amplify/record a smooth, natural-sounding decay from desirous signals produced by the instrument (hereinafter “wanted signals”) to the residual extraneous signals generated by the act of playing the instrument/amplifying the instrument (hereinafter “unwanted signals”). Alternatively, or additionally, the systems and methods contemplated herein may reduce some of the unwanted signals from being amplified/recoded while the instrument is being played (when the wanted signals are being produced). These may be achieved by measuring the input signals (comprising both the wanted and unwanted signals present) and processing those signals before they are received by filter transistors that themselves control the amount and nature of signals received by attenuation and/or muting circuits. Such technology may allow for clean signals to be produced by instruments at concerts, even with heavily overdriven instruments like electric guitars, and for recordings to have reduced unwanted signals, saving significantly on the time to process these recordings.

The present invention will be best understood via the accompanying figures, in which an exemplary preferred embodiment according to the methods and systems contemplated herein is depicted. Specifically, this preferred embodiment is for an electric guitar amplifier. The ideal parameters of this preferred embodiment will be detailed throughout, although it is understood that the present invention need not be limited to those ideal parameters. As such, it will be appreciated that numerous modifications and changes can be made to these diagrams, which may be necessary for different types of instruments and environments (different concert venues, alternative recording equipment, for instance). Additionally, it is worth noting that not every detail and feature is shown in these electric circuit diagrams, an example being that the moving filters in these figures do not explicitly show their power supply. Those skilled in the art would understand and appreciate that it is commonplace to omit those features in these types of diagrams; thus, those artisans would understand, in light of this disclosure, how to configure these stages and their auxiliary features so as to effectively carry out the methods and systems contemplated herein. The symbols used in these electric circuit diagram conform to those used in the International Electrotechnical Commission (IEC).

The term “based on” as used herein refers to a relationship between two signals, in that one signal may be derived from another signal. For example, when an original signal is sent through a filter to produce a filtered signal, the filtered signal may be based on the original signal. A signal based on another signal need not be drastically different from the signal from which it originated as, and as such the two signals may be near identical or one signal may simply be a retransmitted version of the other.

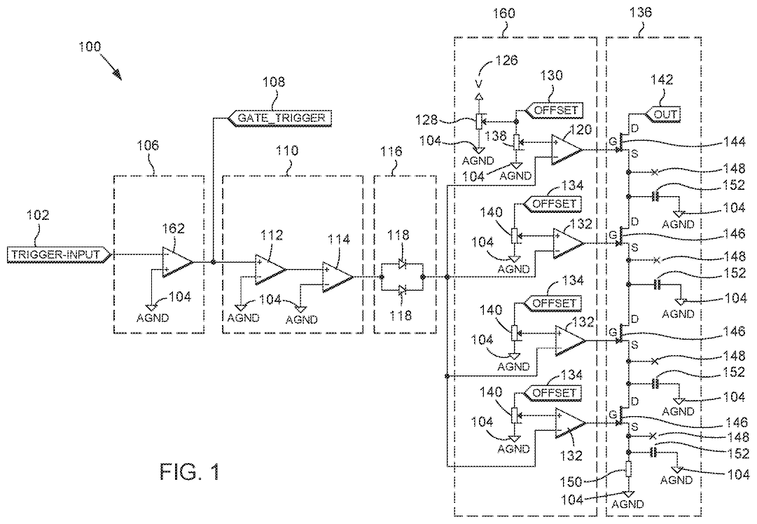

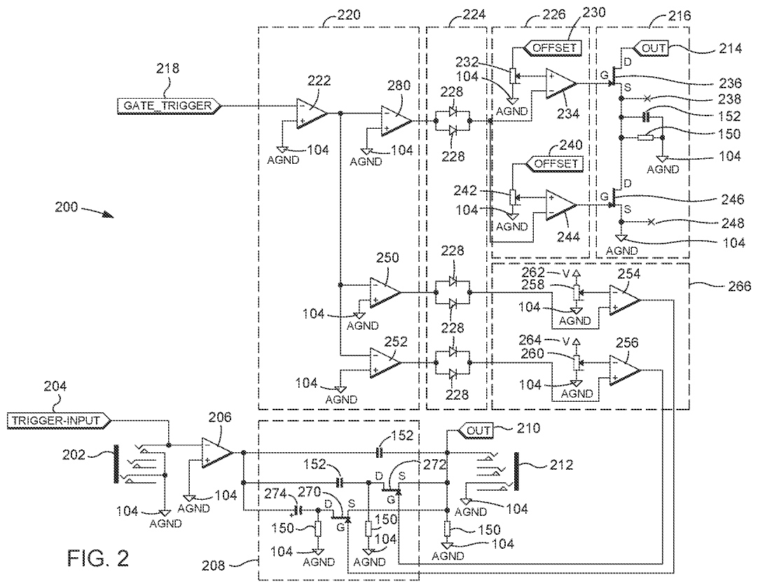

Looking now to FIG. 1, an exemplary preferred embodiment of a simulator electric circuit is shown. Within the simulator circuit 100, a trigger input signal 102 may be received. The trigger input signal 102 may be based on the signal measured by the trigger input 204 in the main circuit 200 and is ideally a retransmission of the signal measured by the trigger input 204. This will be detailed more in the discussion of FIG. 2, but simply put for FIG. 1, the trigger input signal 102 in the simulator circuit 100 will reproduce or substantially reproduce the input signal 202 comprising the wanted signals and unwanted signals generated from a musical instrument electrically connected to the audio signal management system.

Throughout the simulator circuit 100 and the main circuit 200 there may be signal grounds 104, which those skilled in the art would recognize are regularly used in amplifier circuitry as a reference point from which a signal can be measured/compared against. Each of the signal grounds 104 may have a different reference voltage from each other, the signal grounds 104 may all share the same reference voltage, or there can be some combination of one or more groups of signal grounds 104 sharing the same reference voltage and other signal grounds 104 of differing reference voltages. Additionally, both the simulator circuit 100 and the main circuit 200 may comprise numerous moving filters. These moving filters may be high pass filters, low pass filters, bandpass filters, or shelving filters (which includes both high shelf filters and low shelf filters). The cutoff frequencies for these filters may be referred to as a “set frequency”, which can be adjusted between different values. The preferred embodiment discloses a working embodiment which comprises a particular ordering and configuration of these moving filters, but it should be appreciated that such ordering and configuration need not be limited to this embodiment and can therefore be changed to accomplish a similar goal of natural-sounding signal decay and/or removal of unwanted signals. As an example, the inputs which are received at the inverting and non-inverting inputs of the comparators and moving filters herein need not be limited to the configuration shown, although if one were to change these, they should be careful to configure the rest of the circuits properly to ensure that the proper signal processing still occurs.

The simulator circuit 100 may be comprised of many stages, the first of which may be an adjustable trigger input stage 106 comprising an adjustable trigger 162. The adjustable trigger 162 may receive the trigger input signal 102. A low trigger input signal 102 corresponding to a break in playing the instrument (when no more wanted signal is being produced) may cause the adjustable trigger 162 to produce an overdriven signal. In the alternative, when the instrument is being played and a high trigger input signal 102 is received by the adjustable trigger 162, this overdriven signal may not be produced. In this respect, the adjustable trigger 162 may act as an op amp with a high gain. The overdriven signal may serve to simulate an external device that could be related to the musical instrument wired to this amplifier/circuitry. In the preferred embodiment of an electric guitar amplifier, this may simulate an overdriven amplifier or guitar effect.

The overdriven signal this adjustable trigger 162 stage produces may be measured via a gate trigger 108 as a measured overdriven signal. An identical signal or a modified version of this measured overdriven signal may be transmitted to the gate trigger 218 of the main circuit 200, the function of which will be detailed when discussing FIG. 2. The adjustable trigger 162, as its name implies, may be adjusted in terms of how sensitive it is to a change in a trigger input signal 102 and the how overdriven of a signal is produced.

The next stages that follow may function to process the overdriven signal into a processed simulator signal before it is received by a simulator filter transistor 144, 146. The first of these stages may be a simulator filtering stage 110, as is the case in the embodiment of FIG. 1. This stage may have one or more moving filters to process the signal received from the previous stage, that being the overdriven signal in this case. In the preferred embodiment the first simulator filter 112 is a high pass, high shelf filter while the second simulator filter 114 is a low pass filter. The first simulator filter 112 in this embodiment adds+12 dB to the portions of the signal above the set frequency of 6 Hz. The low pass filter 114 in this same embodiment acts as a 2^{nd} order Bessel low pass filter with a set frequency of 5 kHz.

A simulator rectifier stage 116 may receive a simulator pre-rectifier signal, which may be the same signal as that produced by the simulator filtering stage 110 if that stage comes right before the simulator rectifier stage 116. Like most rectifier stages in electric circuits, this stage may allow for the pre-rectifier signal to flow towards the downstream stages in this circuit via the implementation of simulator rectifiers 118. Additionally, this simulator rectifier stage 116 may serve to correlate the incoming signal to trigger the following stages in proportion to the incoming signal of the main rectifier stage 224 in the main circuit 200. This could cause the signals processed by the simulator circuit 100 to be amplified/recorded at the same time as the corresponding signals from the main circuit 200 are amplified/recorded such that a proper matching up of the signals to be amplified/recorded occurs. Otherwise, the resultant signal amplified/recorded may sound unnatural and unbalanced (i.e., one fading out effect is substantially louder than the other).

A simulator pre-comparator signal may be received by a simulator comparator stage 160. If the simulator comparator stage 160 is preceded by the simulator rectifier stage 116, then the output from the simulator rectifier stage 116 could be the simulator pre-comparator signal received at this simulator comparator stage 160. The pre-comparator signal may be received by a simulator main comparator 120. The pre-comparator signal may be compared with a primary simulator voltage signal also received by the simulator main comparator 120 in order to produce an output to be sent to the next stage. The primary simulator voltage signal may be based on a primary simulator voltage from a primary simulator power source 126. In the preferred embodiment, the primary simulator voltage from the primary simulator power source 126 is 18 V.

In the embodiment of FIG. 1, the primary simulator voltage from the primary power source 126 first passes through a level potentiometer 128, with the resultant signal from this process being an offset signal. This offset signal may be measured via the primary offset measurement 130. The offset signal may then pass through a primary attenuation potentiometer 138 to produce the primary simulator voltage signal to be received by the simulator main comparator 120. In an alternative embodiment (not shown in FIG. 1), the primary attenuation potentiometer may be omitted, and the offset signal may act as the primary simulator voltage signal to be received by the simulator main comparator 120. The resultant output from any potentiometer 128, 138, 140, 232, 242, 258, and 260 used herein can depend upon the initial signal passed through the potentiometer and the adjustable configuration of the potentiometer 128, 138, 140, 232, 242, 258, and 260. All potentiometers 128, 138, 140, 232, 242, 258, and 260 used herein may also be similar to conventional potentiometers used in the art and can be adjusted as desired to achieve different levels of noise filtering and noise decay.

The simulator comparator stage 160 may comprise additional simulator comparators 134 which may receive the simulator pre-comparator signal just like the simulator main comparator 120. Each of the additional simulator comparators 134 may also receive an additional simulator voltage signal. The additional simulator voltage signal may be based on an additional offset signal 134, which itself may be based on the primary offset measurement 130. More specifically, the additional simulator voltage signal may be produced via the additional offset signal 134 passing through an additional attenuation potentiometer 140 to produce the additional simulator voltage signal. The additional offset signal 134 may be the same for each additional simulator comparator 132 and additional attenuation potentiometer 140, and as such the threshold value for each additional simulator comparator 132 may be adjusted between one another via different configuration and/or operation from one additional attenuation potentiometer 140 to the next. The output from any additional simulator comparators 132 present may be sent to the next stage. The number of additional simulator comparators 134 need not be limited to three as shown here; therefore, there can be more than three or less than three additional simulator comparators 132.

In what is the last stage of the external device simulator circuit 100 shown in FIG. 1, the attenuation filter stage 136 may receive a processed simulator signal from the previous stage. In the embodiment of FIG. 1, the output of the simulator main comparator 120 from the simulator comparator stage 160 is this processed simulator signal. The processed simulator signal, in general, can be the signal resulting from any filtering/processing stages that is eventually received by a main simulator filter transistor 144. In this respect, the processed simulator signal may be based on the overdriven signal. This main simulator filter transistor 144 may additionally receive an out signal 142 which may be based on the measured output signal 210 from the main circuit 200. This out signal 142 may be received by the main simulator filter transistor 144 and pass through the main simulator filter transistor 144 along with the processed simulator signal to produce a pre-attenuation signal.

The main simulator filter transistor 144 may function as an N-channel JFET. As would be understood by those skilled in the art, a signal received by the main simulator filter transistor 144 configured as an N channel JFET may flow from the drain terminal “D” to the source terminal “S” depending on the processed simulator signal received at gate terminal “G”. The signal produced at the source terminal may be filtered, amplified, attenuated, and/or modified when compared to the original signals received at the drain terminal and the gate terminal. In the embodiment of FIG. 1, the main simulator filter transistor 144 may also act as a moving filter by filtering out certain portions of the signals received at the drain terminal and/or the gate terminal. In the preferred embodiment, the main simulator filter transistor 144 acts as low pass filters that remove the high frequency signals from the received-out signal 142. This could allow for the removal of high frequency unwanted signals such as hissing from being received by the simulator attenuation circuit(s) 148. Following the main simulator filter transistor 144, there may be a simulator attenuation circuit 148. Any simulator attenuation circuit(s) 148 present may, like most conventional electronic attenuators, reduce any signal received without substantially disturbing the waveform of the received signal before such signal is amplified/recorded.

The attenuation filter stage 136 may also comprise additional simulator filter transistors 146 which may receive an additional processed simulator signal at the gate terminal; this signal may be the output from a particular additional simulator comparator 132 from the previous stage. The additional simulator filter transistors 146 may also receive the output from the source terminal of a previous simulator filter transistor 144, 146. For example, in FIG. 1 the first additional simulator filter transistor 146 receives the simulator pre-attenuation signal from the main simulator filter transistor 144. The additional simulator filter transistors 146 may produce an additional pre-attenuation signal which could be received by another simulator attenuation circuit 148.

It can be seen that the out signal 142 and any subsequent simulator pre-attenuation signal may progressively go through the main simulator filter transistor 144 and any following additional simulator filter transistor(s) 146, whose function are modified by the outputs of the simulator comparators 120, 132, and be received by any attenuation circuits 148 present; these features may be configured to work simultaneously to smoothly decay the wanted signal in such a way that sounds natural and smooth to the human ear. The parameters and functionality of the primary simulator power source 126, the simulator comparators 120, 134, and the potentiometers 128, 138, 140 associated therewith may be configured and modified so as to create a certain decay effect depending on the received trigger input signal 102. Depending on the musical instrument and environment, it may be necessary to configure and modify these stages differently to achieve the desired result. It is worth noting that there need not be a one-to-one correspondence of simulator comparators 120, 132 to simulator filter transistors 144, 146 as depicted here. For example, the output from one simulator comparator 120, 132 may be received at the gate of more than simulator filter transistor 144, 146. Likewise, there need not be a one-to-one ratio of simulator attenuation circuits 148 to simulator filter transistors 144, 146.

The attenuation filter stage 136 may include additional features that those skilled in the art would understand the purpose and function of, including signal grounds 104, resistors 150, and capacitors 152. These capacitors 152 may function as bypass capacitors, as shown here in the embodiment of the attenuation filter stage 136 in FIG. 1.

Turning to FIG. 2 now, an exemplary embodiment of a main circuit is shown. This main circuit 200 may work alongside the simulator circuit 100 as will be shown more clearly herein. An input signal 202 may be provided to the main circuit 200 which could be from a musical instrument electrically connected to the main circuit 200. A trigger input 204 may measure this input signal 202 as a measured input signal. The measured input signal may be transmitted as the same signal or a modified version thereof as the trigger input signal 102. The input signal 202 may also be received by an op amp 206 which may send its output to a main pass filter stage 208 (which will be detailed later herein). After being processed in the main filter stage 208, the resulting signal may be measured by an out measurement 210 as a measured-out signal before being sent as an output signal 212 to any further amplifier circuitry/recording circuitry. The signal measured at the out measurement 210 may be transmitted as the same signal or a modified version thereof as the out signal 142 in the simulator circuit 100 and the out signal 214 of the muting stages 216 of this main circuit 200.

Looking now to a different part of the main circuit 200, a gate trigger signal 218 may be received and fed into one or more processing stages to eventually produce a processed gate attenuation signal and/or a processed gate mute signal. In the embodiment of FIG. 2, the trigger signal 218 starts this process by first being received by the gate trigger filter stage 220. This gate trigger signal 218 can be retransmitted from the simulator circuit 100 as the same signal or a modified version of the signal measured by the gate trigger 108. In this respect, the gate trigger signal 218 may be based on the overdriven signal. The gate trigger signal 218 in the main circuit 200 may thus transmit a higher signal, and thus “trigger” the gate, when the instrument is no longer being played, as the low trigger input signal 202, 102 may correspond to a low gate trigger signal 108 in the simulator circuit 100.

A gate trigger filter stage 220 may first receive the gate trigger signal 218. This gate trigger filter stage 220 may first comprise a first gate filter 222 to filter any signal received. In the preferred embodiment, this first gate filter 222 is a high pass filter that has a set frequency of 66 Hz with a +12 dB high shelf, similar to the aforesaid preferred embodiment of first simulator filter 112 in the simulator circuit 100. The output of the first primary filter 222 of the main circuit 200 may then be sent to one or more pathways, with this FIG. 2 having exactly two branching pathways. The top pathway (a gate pathway) corresponding to the muting comparator stage 226 and the muting circuit stage 216 will be detailed first, while the bottom pathway (an auxiliary pathway) corresponding to the comparator filter stage 266 and the main filter stage 208 will be detailed afterwards.

On the top gate pathway, the output from the first gate filter 222 may be received by a second gate filter 280. In the preferred embodiment, this second gate filter 280 is a 2′ order Bessel low pass filter with a set frequency of 2.8 kHz. A gate rectifier stage 224 may receive a gate pre-rectifier signal from the previous stage, which is the output of the second gate filter 280 in the case of the embodiment of FIG. 2. This gate rectifier stage 224 may function similarly or substantially the same as the simulator circuit rectifier stage 116 such that any signal passing through any gate rectifier(s) 228 present can be properly correlated in proportion to those that pass through any gate rectifier(s) 228 on the second lower pathway and the simulator rectifiers 118 in the simulator circuit rectifier stage 116. This way, the signals can properly be amplified/recorded alongside each other to produce the desired fade out/filtered sound in a natural-sounding harmonious fashion.

In the muting comparators stage 226, a muting gate comparator 244 may receive a gate pre-comparator signal from the previous stage (the output from the gate rectifiers 228 in the embodiment of FIG. 2) alongside a secondary gate voltage signal based on a muting offset signal 240. The muting offset signal 240 may be the same or a modified version of the primary offset measurement 130 in the simulator circuit 100. In this respect, it can be seen that the muting offset signal 240 and the secondary gate voltage signal may be based on the primary simulator voltage from the primary simulator power source 126 in the simulator circuit 100. The secondary gate voltage signal may be produced via the muting offset signal 240 being sent through a muting potentiometer 242 which can selectively adjust the muting offset 240 signal before it is produced as the secondary gate voltage signal to be received by the muting gate comparator 244. The output from this muting gate comparator 244 may next be sent to the following stage, in this case the muting circuit stage 216.

One or more additional attenuation gate comparators 234 may be present in the muting comparator stage 226 which may also receive the output signal from the previous stage (in FIG. 2, the gate pre-comparator signal). Similar to the muting gate comparator 244, the one or more attenuation gate comparators 234 may receive a signal from an attenuation offset signal 230 which may be selectively adjusted via an attenuation potentiometer 232. The attenuation offset signal 230 may also be based on the offset signal 130 measured in the simulator circuit 100. The functionality and nature of the components of these one or more attenuation comparators 234 may be the same and/or modified in comparison to the muting comparator 244, its muting offset signal 240, and its muting potentiometer 242. There can be more than one attenuation comparator 234, and as such the main circuit 200 need not be limited to just one as shown in the embodiment of FIG. 2. The attenuation offset signal 230 and the muting offset signal 240 may be the same signal or different between each other.

The muting circuit stage 216 may have one or more attenuation gate transistors 236 and one or more muting gate transistors 246 which may receive signals from the previous stage. Specifically, the attenuation gate transistor(s) 236 may receive a processed gate attenuation signal while the muting gate transistor(s) 246 may receive a processed gate mute signal. In the case of the preferred embodiment of FIG. 2, the processed gate attenuation signal is the output of the attenuation gate comparator 234 and the processed gate mute signal is the output of the muting gate comparator 244. The gate transistors 236, 246 may be configured as N channel JFETS and may thus receive these particular signals at their gate terminal “G”. The processed gate attenuation signal and the processed gate mute signal may therefore turn the gate transistors 236, 246 on and off and/or control the amount/nature of the signal produced at the source terminal “S”.

This muting circuit stage 216 may additionally receive an out signal 214 which, as mentioned previously, could be the same or a modified version of the aforesaid measured output signal 210 from elsewhere in the main circuit 200. The out signal 214 may first be received by an attenuation gate transistor 236 at the drain terminal “D”. After the attenuation gate transistor 236 receives signals at the gate and drain terminals, the attenuation gate transistor may produce a signal at the source terminal “S”. This resulting signal, a gate pre-attenuation signal, can then be received by an attenuation circuit 238 and may also be received by any additional attenuation gate transistors 236 that may follow this first attenuation gate transistor 236 (similar to the series of simulator gate transistors 144, 146 in FIG. 1). This attenuation circuit 238 may be configured similarly to attenuation circuits known and utilized by those skilled in the art so as to attenuate a received signal before sending it to a sound amplifier/recording equipment. This attenuation circuit 238 may contribute to the decay/fade-out effect, either by working alone or alongside the simulator attenuation circuits 148 in the main circuit 100.

The gate pre-attenuation signal from an attenuation gate transistor 236 may also be received by a muting transistor 246 at its drain terminal “D”, which also may act as an N channel JEFT. The signal received at the gate “G” of the muting transistor the aforementioned processed gate mute signal, may be the output of the muting comparator 244. The leftover modified signal leaving from the source “S” of the muting transistor, a gate pre-mute signal, may then be received by a muting circuit 248. This muting circuit 248 may be constructed similarly to muting circuits known and conventionally used in the art. It can be seen that any attenuation circuit(s) 238 present, when the attenuation transistor 236 is activated, may allow for a natural fading out of the signal until the muting transistor 246 is activated, causing a muting or “gating” of the signal, thus cutting off a signal from being amplified/recorded after a natural-sounding fade out of the signal occurs. It can be seen therefore that the lingering noise floor can be prevented from being amplified/recorded after a certain fade-out/decay effect occurs. This could serve to enhance the satisfaction of hearing this decay effect, as it can add a sense of finality while simultaneously preventing unwanted signals from being heard by a listener. The attenuation offset signal 230 and the muting offset signal 240 and the configuration of the gate comparators 234, 244 may therefore determine the conditions in which such attenuation and gating effects occur.

Now we shall switch our focus onto the second lower pathway (auxiliary pathway) of FIG. 2 which stems from the first gate filter 222. The gate high pass filtered signal from the first gate filter 222 may be received by one or more auxiliary filters 250, 252. Any auxiliary filters 250, 252 present may be configured the same as one another or differently from each other. In the preferred embodiment, one of the auxiliary filters 250 is a 2^{nd} order Bessel low pass filter with a set frequency of 110 Hz, while the other auxiliary filter 252 is a 2^{nd} order Bessel low pass filter with a set frequency of 220 Hz.

The output from the auxiliary filters 250, 252 may be the auxiliary signal received by the gate rectifiers 228 of the main rectifier stage 224, the function and purpose of which was mentioned previously above. The gate rectifier(s) 228 that receive the auxiliary signal (auxiliary rectifier) may of course be different than the gate rectifiers 228 that receive the gate pre-rectifier signal from the gate pathway.

A main comparator stage 266 may receive a rectified auxiliary signal from the main rectifier stage 224 or from whichever stage may come prior to the main comparator stage 266. One or more auxiliary comparators 254, 256 may receive such signals. The main circuit 200 can be configured as shown here such that each auxiliary filter 250, 252 in the gate trigger filter stage 220 corresponds to a particular auxiliary comparator 254, 256 in this main comparator stage 266, but in alternative embodiments there could be more than one auxiliary filter in one stage that corresponds to one or more auxiliary comparators in the other stage. Both of the auxiliary comparators 254, 256 may also receive an input supplied from an auxiliary power source 262, 264 that could first be adjusted via a power source potentiometer 258, 260. The voltage of the auxiliary power sources 262, 264 are both 18V in the preferred embodiment, but the auxiliary power sources 262, 264 need not share the same voltage in other embodiments.

The main filter stage 208 may comprise one or more high pass filter transistors 270, 272, which can be configured as N channel JFETS, which may receive a pre-high pass filter signal. This pre-high pass filter signal may be from the auxiliary comparators 254 and 256. These particular signals may be received by high pass filter transistors 270, 272 at the gate terminal “G” such that the signal received at the gate “G” may determine the amount/nature of the signal that flows out from the source terminal “S” when compared to the signal received at the gate terminal “G”.

As mentioned earlier, the input signal 202 may first be introduced to an op amp 206 and sent to the main filter stage 206; this signal may be referred to as a pre-capacitor signal. The pre-capacitor signal may then be introduced to a capacitor 152 or a polarized capacitor 274, both of which may act as a coupling capacitor as shown in the embodiment of FIG. 2. The resultant signal may at least partially produce the output signal 212, as shown in the top pathway of FIG. 2 in which the pre-capacitor signal is introduced to the capacitor 152 and subsequently not introduced to any high pass filter transistors 270, 272 before contributing to the output signal 212. Alternatively, the resultant signal from a capacitor 152 or a polarized capacitor may be a post-capacitor signal which may be received at the drain terminal “D” of one of the high pass filter transistors 270, 272.

The high pass filter transistors 270, 272, as their name indicates, may act as high pass filters to remove lower frequency unwanted signals such as rumbling noise. The configuration of the auxiliary components 250, 252, 258, 260, 262, and 264 and the signal that is received at the gate terminal of the high pass filter transistors 270, 272 may control the functionality of these high pass filter transistors ideally such that the low frequency unwanted signals may be removed when the musical instrument is played at high registers. This in turn may affect the measured output signal 210 and subsequently the out signals 142, 216, which may prevent the removed low frequency signals from being received by the attenuation circuits 148, 238.

Just like the simulator circuit 100, this main circuit 200 may comprise numerous signal grounds 104, capacitors 152, and resistors 150, each of which could be configured similarly to each other or differently.

It can be seen that the simulator circuit 100 and the main circuit can process an input signal 202 from a musical instrument on various levels to allow for a desired natural-sounding fade out of a wanted signal, the removal of noise floor during a break in playing the musical instrument, the removal of undesirous high frequency noises like hissing, and the removal of low frequency noises when playing the musical instrument in high registers. The simulator filter transistors 144, 146 of the simulator circuit 100 may dynamically react and work alongside the attenuation gate transistor(s) 236 of the main circuit 200 to cooperatively produce a smooth fade out effect of the wanted signal before the muting gate transistor 246 activates to cut off these signals and prevent the noise floor from being amplified/recorded. The filtering of the high pass filter transistors 270, 272 and the simulator filter transistors 144, 146 may also aid in preventing high/low frequency unwanted signals from being amplified/recorded. Such an audio signal management system may save tremendous amounts of time in recording studios when it comes to processing after recording as well as improve the sound quality at concerts when compared to prior art amplifiers.

The above description is given by way of example, and not limitation. Given the above disclosure, one skilled in the art could devise variations that are within the scope and spirit of the invention disclosed herein, including various ways of modifying the audio signal management system and methods contemplated herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An audio signal management system which allows for a smooth decay of wanted signals from a musical instrument, the system comprising:
a main circuit, the main circuit comprising:
a trigger input operative to measure an input signal of the musical instrument as a measured input signal; and
an out measurement operative to measure an output signal of the musical instrument as a measured output signal, the output signal being based on the input signal;
a simulator circuit, the simulator circuit comprising:
an adjustable trigger operative to receive a trigger input signal, the trigger input signal being based on the measured input signal, the adjustable trigger being further operative to produce an overdriven signal;
a main simulator filter transistor operative to receive an out signal, the out signal being based on the measured output signal, the main filter transistor being further operative to receive a processed simulator signal, the processed simulator signal being based on the overdriven signal, the main filter transistor being further operative to produce a simulator pre-attenuation signal; and
a simulator attenuation circuit operative to receive the simulator pre-attenuation signal.

2. The system of claim 1, wherein the simulator circuit further comprises at least one simulator moving filter and a simulator rectifier; and
wherein the processed simulator signal is processed via the at least one simulator moving filter receiving the overdriven signal and filtering the overdriven signal to produce a simulator pre-rectifier signal, followed by the simulator rectifier receiving the simulator pre-rectifier signal and rectifying the simulator pre-rectifier signal to produce the processed simulator signal.

3. The system of claim 2, wherein the at least one simulator moving filter comprises a simulator high pass filter and a simulator low pass filter; and
wherein the simulator pre-rectifier signal is processed via the simulator high pass filter receiving the overdriven signal and filtering the overdriven signal to produce a first simulator filter intermediate signal, followed by the simulator low pass filter receiving the first simulator filter intermediate signal and subsequently filtering the first simulator filter intermediate signal to produce the simulator pre-rectifier signal.

4. The system of claim 3, wherein the simulator high pass filter is a +12 dB high shelf filter with a set frequency of 66 Hz.

5. The system of claim 3, wherein the simulator low pass filter is a 2 nd order Bessel low pass filter with a set frequency of 5 kHz.

6. The system of claim 1, wherein the simulator circuit further comprises at least one simulator moving filter, a simulator rectifier, and a simulator main comparator;
wherein the simulator main comparator is operative to receive a primary simulator voltage signal, the primary voltage simulator signal being based on a primary simulator voltage from a primary simulator power source; and
wherein the processed simulator signal is processed via the at least one simulator moving filter receiving the overdriven signal and filtering the overdriven signal to produce a simulator pre-rectifier signal, followed by the simulator rectifier receiving the simulator pre-rectifier signal and rectifying the simulator pre-rectifier signal to produce a simulator pre-comparator signal, followed by the simulator main comparator receiving the simulator pre-comparator signal and the primary simulator voltage signal and subsequently comparing the simulator pre-rectifier signal with the primary simulator voltage signal to produce the processed simulator signal.

7. The system of claim 6, wherein the simulator circuit further comprises a level potentiometer, and
wherein the primary simulator voltage signal is produced via the level potentiometer receiving the primary simulator voltage from the primary simulator power source to produce the primary simulator voltage signal.

8. The system of claim 6, wherein the simulator circuit further comprises:
an additional simulator comparator operative to receive the simulator pre-comparator signal, the additional simulator comparator being further operative to receive an additional simulator voltage signal, the additional simulator voltage signal being based on an offset signal, the offset signal being based on the primary simulator voltage from the primary simulator power source, the additional comparator being further operative to produce an additional processed simulator signal,
an additional simulator filter transistor being operative to receive the simulator pre-attenuation signal and the additional processed simulator signal, the additional simulator filter transistor being further operative to produce an additional simulator pre-attenuation signal, and
an additional simulator attenuation circuit operative to receive the additional simulator pre-attenuation signal.

9. The system of claim 8, wherein the system further comprises a level potentiometer, a primary attenuation potentiometer, and an additional attenuation potentiometer,
wherein the offset signal is produced via the level potentiometer receiving the primary voltage from the primary power to produce the offset signal,
wherein the primary simulator voltage signal is produced via the primary attenuation potentiometer receiving the offset signal to produce the primary simulator voltage signal, and
wherein the additional simulator voltage signal is produced via the additional attenuation potentiometer receiving the offset signal to produce the additional simulator voltage signal.

10. The system of claim 1, wherein the main simulator filter transistor is a dynamic low pass filter N channel JFET.

11. The system of claim 10, wherein the main simulator filter transistor receives the out signal at the drain of the main simulator filter transistor and receives the processed simulator signal at the gate of the main simulator filter transistor.

12. The system of claim 1, wherein the simulator circuit further comprises
a gate trigger operative to measure the overdriven signal as a measured overdriven signal, and
wherein the main circuit further comprises:
an attenuation gate transistor operative to receive the out signal, the attenuation gate transistor being further operative to receive a processed gate attenuation signal, the processed gate attenuation signal being based on the measured overdriven signal, the attenuation gate transistor being further operative to produce a gate pre-attenuation signal,
an attenuation gate circuit operative to receive the gate pre-attenuation signal,
a muting gate transistor operative to receive the gate pre-attenuation signal, the muting gate transistor being further operative to receive a processed gate mute signal based on the measured overdriven signal, the muting gate transistor being further operative to produce a gate pre-mute signal,
a muting circuit operative to receive the gate pre-mute signal.

13. The system of claim 12, wherein the main circuit further comprises
at least one gate filter operative to receive a gate trigger signal, the gate trigger signal being based on the measured overdriven signal,
a gate rectifier,
an attenuation gate comparator operative to receive a tertiary gate voltage signal, the tertiary gate voltage signal being based on a primary simulator voltage from a primary simulator power source, and
a muting gate comparator operative to receive a secondary gate voltage signal based on the primary simulator voltage from the primary simulator power source,
wherein the gate pre-mute signal is processed via the at least one gate filter receiving the gate trigger signal and filtering the gate trigger signal to produce a gate pre-rectifier signal, followed by the gate rectifier receiving the gate pre-rectifier signal and rectifying the gate pre-rectifier signal to produce a gate pre-comparator signal, followed by the muting gate comparator receiving the gate pre-comparator signal and comparing the gate pre-comparator signal to the additional gate voltage signal to produce the gate pre-mute signal; and
wherein the gate pre-attenuation signal is processed via the attenuation gate comparator receiving the gate pre-comparator signal and comparing the gate pre-comparator signal to the primary gate voltage signal to produce the gate pre-attenuation signal.

14. The system of claim 13, wherein the at least one filter comprises a gate high pass filter and a gate low pass filter, and
wherein the gate trigger signal is filtered to produce the gate pre-rectifier signal via the gate high pass filter receiving the gate trigger signal and producing a gate high pass filtered signal, followed by the gate low pass filter receiving the gate high pass filtered signal and filtering the gate high pass filtered signal to produce the gate pre-rectifier signal.

15. The system of claim 14, wherein the gate low pass filter is a 2′ order Bessel low pass filter with a set frequency of 2.8 kHz.

16. The system of claim 14, wherein the main circuit further comprises:
an op amp operative to receive the input signal and produce a pre-capacitor signal,
an auxiliary low pass filter operative to receive the gate high pass filtered signal and produce an auxiliary signal,
an auxiliary rectifier operative to receive the auxiliary signal and produce a rectified auxiliary signal,
an auxiliary comparator operative to receive the rectified auxiliary signal, the auxiliary comparator being further operative to receive a primary auxiliary voltage signal, the primary auxiliary voltage signal being based on a primary auxiliary voltage from a primary auxiliary power supply, the auxiliary comparator being further operative to produce an auxiliary pre-high pass filter signal,
an auxiliary high pass filter transistor being operative to receive a post-capacitor signal and the pre-high pass filter signal, the post-capacitor signal being based on the pre-capacitor signal, the auxiliary high pass filter transistor being further operative to at least partially produce the output signal.

17. The system of claim 16, wherein the auxiliary high pass filter transistor is an N channel JEFT, wherein the auxiliary high pass filter transistor receives the signal based on the pre-capacitor signal at the drain terminal, and wherein the auxiliary high pass filter transistor receives the auxiliary pre-high pass filter signal at the gate terminal.

18. The system of claim 16, wherein the main circuit further comprises a coupling capacitor, and wherein the post-capacitor signal is produced via the coupling capacitor receiving the pre-capacitor signal and producing the post-capacitor signal.

19. The system of claim 16, wherein the main circuit further comprises:
an additional auxiliary low pass filter operative to receive the gate high pass filtered signal and produce an additional auxiliary signal,
an additional auxiliary rectifier operative to receive the additional auxiliary signal and produce an additional rectified auxiliary signal,
an additional auxiliary comparator operative to receive the additional rectified auxiliary signal, the additional auxiliary comparator being further operative to receive an additional auxiliary voltage signal, the additional auxiliary voltage signal being based on an additional auxiliary voltage from an additional auxiliary power supply, the additional auxiliary comparator being further operative to produce an additional pre-high pass filter signal,
an additional auxiliary high pass filter transistor being operative to receive an additional post-capacitor signal based on the pre-capacitor signal and the additional pre-high pass filter signal, the additional post-capacitor signal being based on the pre-capacitor signal, the additional auxiliary high pass filter transistor being further operative to at least partially produce the output signal,
wherein the additional post-capacitor signal is produced via a polarized capacitor receiving the pre-capacitor signal to produce the additional post-capacitor signal.

20. A method of creating a smooth decay of wanted signals from a musical instrument, the method comprising the steps of:
measuring an input signal of a musical instrument as a measured input signal,
measuring an output signal of a musical instrument as a measured output signal, the output signal being based on the input signal,
producing an overdriven signal in response to a break in playing the musical instrument via an adjustable trigger receiving a trigger input signal and producing the overdriven signal, the trigger input signal being based on the measured input signal,
processing the overdriven signal to produce a processed simulator signal, and
creating a decay effect via at least one simulator transistor receiving an out signal and the processed simulator signal and producing a simulator pre-attenuation signal, followed by at least one attenuation circuit receiving the pre-attenuation signal,
wherein the out signal is based on the measured output signal, and
wherein the simulator transistor is an N channel JEFT that receives the out signal at the drain terminal, and the processed simulator signal at the gate terminal.
